(19) United States
(12) Patent Application Publication
(10) Pub. No.: US 2005/0150115 A1
(43) Pub. Date: Jul. 14, 2005

(54) Knife with partially exposed blade when closed

(76) Inventor: Robert J. Hanna, San Diego, CA (US)

Correspondence Address: David R. Preston;David R. Preston & Associates A.P.C., Suite 205, 12625 High Bluff Drive, San Diego, CA, 92130, US

(21) Appl. No.: 11/018,635

(22) Filed: Dec. 20, 2004

Related U.S. Application Data
(63) Continuation-in-part of application No. 10/146,530, filed on May 15, 2002, now abandoned.

(51) Int. Cl. B26B 3/06

(52) U.S. Cl. 30/155; 30/294

(57) ABSTRACT

This invention provides an article of manufacture for a knife or cutting tool that can cut materials such as webbing and cording without opening the knife. More particularly, the present invention relates to knives with blades that are partially exposed for use when the knife is closed or the blade is sheathed.

### CROSS REFERENCE TO RELATED APPLICATIONS

The present application is a Continuation-in-Part of U.S. patent application Ser. No. 10/146,530 filed on May 15, 2002, entitled “Knife With Partially Exposed Blade When Closed” and naming Robert J. Hanna as inventor, which is incorporated herein by reference in its entirety.

### TECHNICAL FIELD

The present invention generally relates to cutting tools and knives. More particularly, the present invention relates to knives with blades that are partially exposed and usable, when the blade is folded closed or sheathed.

### BACKGROUND OF THE INVENTION

Knives and other cutting tools often use a sheathing mechanism to protect the blade from damage and to prevent accidental cutting of the user or some other object that the blade contacts. One problem with these devices is that they must be “opened” so that the blade may be used. For example, many people carry pocketknives, but these devices have the problem that they must be opened for use and they can unexpectedly close, and when they are open they are dangerous. An inherent problem with many of these devices is that, in emergency situations or under stress, the operator may cut himself or the person he is attempting to assist. There are many situations when it is desirable to be able to cut something without opening the knife or completely exposing the blade. For example, during an automobile accident, the seatbelts abruptly lock and the occupants are unable to quickly escape from the vehicle. A similar type of entrapment can happen to skydivers, if the parachute lines become tangled in a tree. In other situations, emergency personnel may have to remove clothing or entangling rope from a victim. In these situations, a conventional knife may be used. However, the victim is at risk of being cut by the blade, especially if the blade is used incorrectly or if the knife slips in the hand of the user. Certain tools for cutting seatbelts and the like, by emergency workers, have been developed, but these tools tend to be bulky and would not ordinarily be carried by someone on a daily basis.

### BRIEF SUMMARY OF THE INVENTION

With the foregoing in mind, one aspect of the present invention relates to a knife including: a blade; a handle or sheath or scabbard, with one or more slots open to an outside surface of the handle or sheath or scabbard; and an engagement means for reversibly engaging the handle or sheath or scabbard and opening and closing the knife or sheathing. In preferred aspects of the present invention, when the knife is in the closed position, the slot exposes a portion of the cutting surface of the blade, and the slot permits using the blade to cut items without opening the knife. In preferred aspects of the present invention, the slot is sized to allow or to guide the passage of materials to be cut onto the blade, while optionally protecting the user and victim from accidentally being cut.

In certain aspects of the present invention, the slot is generally curved and guides materials to be cut onto the blade, while the knife is closed or sheathed. In other aspects of the present invention, the slot is generally straight and guides materials to be cut onto the blade to be cut, while the knife is closed or sheathed. In preferred aspects of the present invention, when the knife is in the closed position or sheathed, the knife is generally able to cut the same materials that the blade is able to cut in the opened position, as long as the material fits into the slot. The materials to be cut include, but are not limited to, seatbelts, webbing, harnesses, rope, string, yarn, banding, zip ties, flex cuffs, and the like, light weight cording, medium weight cording, heavy weight cording, thin wire, small branches and sticks, paper and cardboard, skin, hair, shoe laces, CORDURA®, rubber rope or banding, plastic and clothing.

The present invention includes a variety of arrangements for the slot and the blade. In certain aspects of the present invention, the slot begins near the midpoint of the handle or sheath or scabbard and angles generally towards the butt end of the handle or sheath or scabbard. In additional aspects of the present invention, the slot begins near the midpoint of the handle or sheath or scabbard and angles generally toward the front end of the handle or sheath or scabbard. In further aspects of the present invention, the slot begins generally near the butt end of the handle or sheath or scabbard and angles generally towards the midpoint of the handle or sheath or scabbard. In still further aspects of the present invention, the slot begins in the butt end of the handle or sheath or scabbard and extents generally toward the midpoint of the handle or sheath or scabbard. In additional further aspects of the present invention, the slot begins generally near the front end and angles generally toward the midpoint of said handle or sheath or scabbard.

In certain aspects of the present invention, the knife is reversibly foldable and the blade is retained in a storage cavity, within the handle, when the knife is in the closed position. The present invention contemplates various methods of opening and closing the knife. In certain aspects of the present invention, the blade has a gripping region or finger grasping protrusion, which may include a thumb stud or a finger hole, for opening a folding knife. In certain aspects of the present invention, the engagement means includes a pivot means for opening the knife. Preferred aspects of the present invention include a locking mechanism for locking the blade in place when the knife is open. In certain aspects of the present invention, the pivot means and locking mechanism include, but are not limited to, a self-biasing cam lock assembly. Preferred aspects of the present invention include a cavity for holding the blade within the handle, when the knife is closed. It follows that in certain aspects contemplated by the present invention, the user grips the blade, by the gripping region, and pulls the blade out of its groove in the handle. The user continues to pull the blade and pivot the blade about the engagement means, until the blade and the handle are properly engaged and the blade locks into place. The knife may then be used as knives customarily are used.

In other aspects of the present invention, the knife is a switchblade type of device, that operates on a spring mechanism and the blade is enclosed within the handle when the knife is closed. In further aspects of the present invention there is a spring-loaded mechanism for ejecting the blade from the handle and thus opening the knife. Preferred aspects of the present invention include a locking mechanism for locking the blade in place when the knife is open. Preferred aspects of the present invention include a groove for holding the blade when the knife is closed. It follows that in certain embodiments of the present invention, that the user holds the handle and actuates the locking mechanism. This causes the blade to eject from its groove in the handle and become engaged with the handle. After the blade and the handle have become engaged, the knife can be used as knives customarily are used.

The present invention also contemplates a knife that is not closable or movable, but is covered by a removable sheath or scabbard. In this aspect of the present invention, the sheath or scabbard has at least one slot for exposing the blade of the knife for cutting without unsheathing the blade in configurations similar to such slot or slots in a handle. The blade may be made of a variety of metals and metal combinations, plastic, ceramics, and the like, that are commonly used in the art. In preferred aspects of the present invention at least a portion of said cutting surface of the blade is serrated. A variety of serration patterns that are commonly used in the art are acceptable. Serration of the blade can promote the cutting of certain materials by protecting the sharpness of the cutting surface and gripping the material being cut.

### BRIEF DESCRIPTION OF THE DRAWINGS

FIG. 1 is a side view of the knife, with partially exposed blade when closed, in the open position;

FIG. 2 is a side view of the knife of FIG. 1, in the closed position, showing the pivotably mounted engagement means to reversibly engage the knife blade with the handle; wherein when the knife blade is engaged with the handle substantially along the length of the handle, at least a portion of the cutting surface of the knife blade is exposed by the slot;

FIG. 3 is a bottom plan view of the knife of FIG. 1, in the closed position;

FIG. 4 is a side view of the knife of FIG. 1, in the closed position, showing the side of the knife opposite from the side shown in FIG. 2;

FIG. 5 is a butt end plan view of the knife of FIG. 1, in the closed position;

FIG. 6 is a front end plan view of the knife of FIG. 1, in the closed position;

FIG. 7 is a top plan view of the knife of FIG. 1, in the closed position;

FIG. 8 is a side view of the knife of FIG. 1, in the open position, showing an alternate version of the slot wherein the slot begins generally near the front end and extends generally toward the midpoint of the handle;

FIG. 9 is a side view of the knife of FIG. 1, in the open position, showing an alternate version of the slot wherein the slot begins generally near the midpoint and extends generally toward the butt end of the handle;

FIG. 10 is a side view of the knife of FIG. 1, in the open position, showing an alternate version of the slot wherein the slot begins generally near the butt end and extends generally toward the midpoint of the handle;

FIG. 11 is a side view of the knife of FIG. 1, in the open position, showing an alternate version of the slot wherein the slot begins generally near the front end and extends generally toward the midpoint of the handle;

FIG. 12 is a side view of the knife of FIG. 1, in the open position, showing an alternate version of the slot wherein the slot begins at the butt end and extends generally toward the midpoint of the handle;

FIG. 13 is a side view of the knife of FIG. 1, in the open position, showing an alternate version of the slot; wherein the slot begins generally near the butt end and extends generally toward the midpoint of the handle

FIG. 14 is a side view of the knife, with removable scabbard, inside the removable scabbard.

FIG. 15 is a side view of the knife of FIG. 14, inside the removable scabbard, showing an alternate version of the slot wherein the slot begins near the midpoint and extends generally toward the front end of the scabbard;

FIG. 16 is a side view of the knife of FIG. 14, inside the removable scabbard, showing an alternate version of the slot wherein the slot begins near the butt end and extends generally toward the midpoint of the scabbard;

FIG. 17 is a side view of the knife of FIG. 14, inside the removable scabbard, showing an alternate version of the slot wherein the slot begins near the front end and extends generally toward the midpoint of the scabbard;

FIG. 18 is a side view of the knife of FIG. 14, inside the removable scabbard, showing an alternate version of the slot wherein the slot begins at the butt end and extends generally toward the midpoint of the scabbard;

FIG. 19 is a front end plan view of the knife of FIG. 14, inside the removable scabbard;

FIG. 20 is a butt end plan view of the knife of FIG. 14, inside the removable scabbard;

FIG. 21 is a top plan view of the knife of FIG. 14, inside the removable scabbard;

FIG. 22 is a bottom plan view of the knife of FIG. 14, inside the removable scabbard;

FIG. 23 is a side view of the knife of FIG. 14, inside the removable scabbard;

FIG. 24 is a side view of the knife of FIG. 14, inside the removable scabbard, showing a side of the knife opposite from the side shown in FIG. 23.

### DETAILED DESCRIPTION

Unless otherwise stated, all technical terms used herein have the same meaning as commonly understood by one of ordinary skill in the art to which this invention belongs. Generally, the nomenclature used herein is that well known and commonly employed in the art.

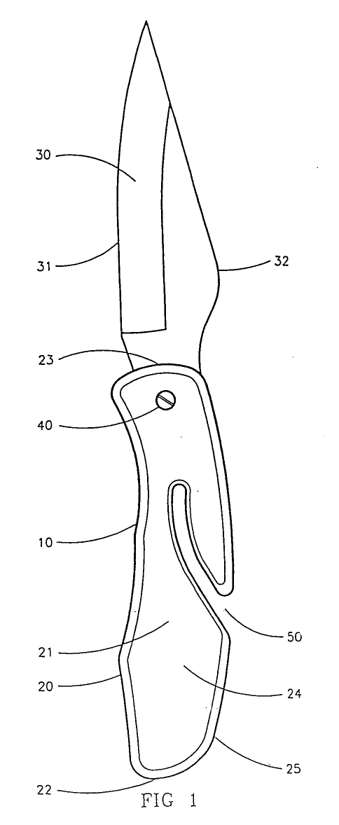

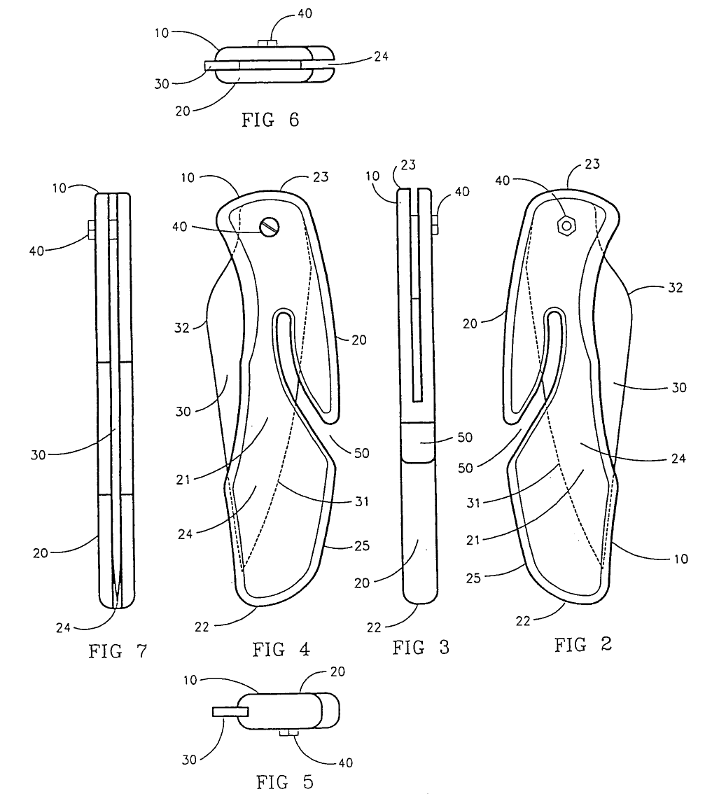

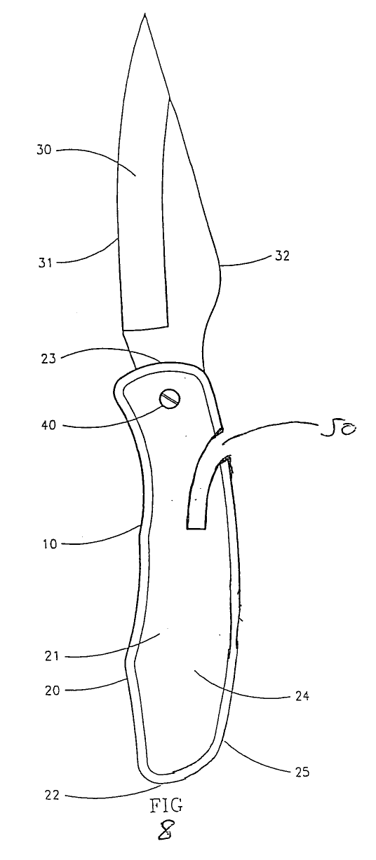

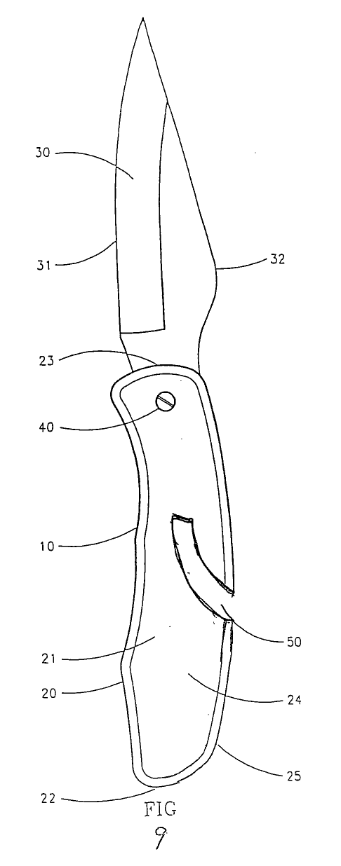

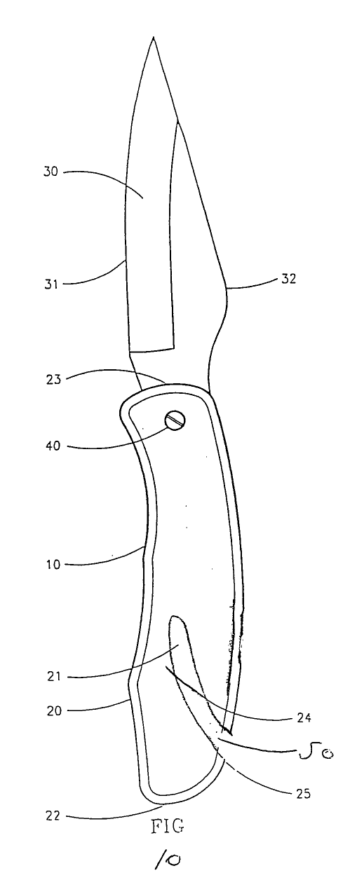

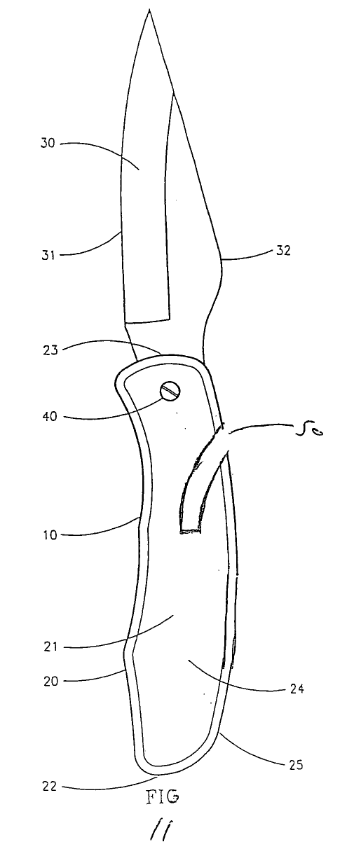

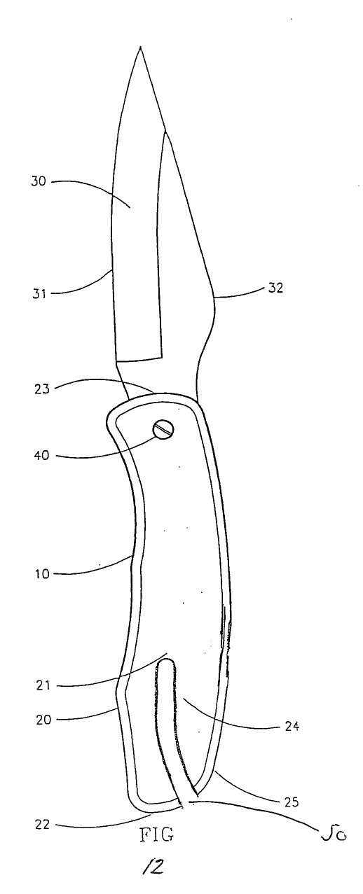

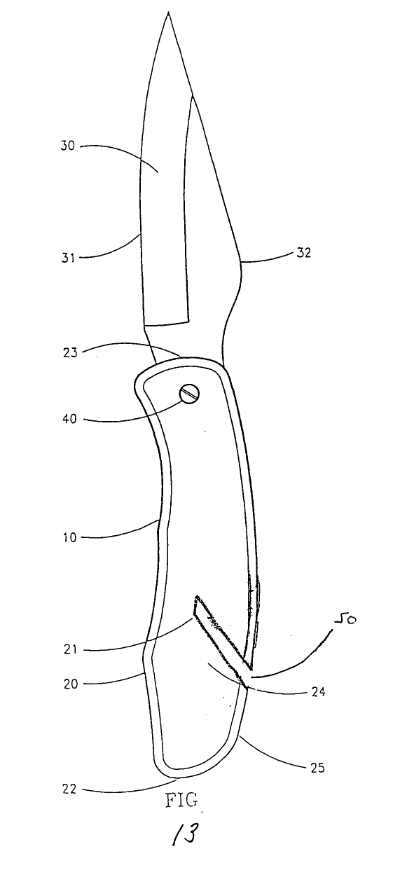

With the foregoing in mind, one aspect of the present invention relates to a knife 10, shown in FIG. 1, including: a blade 30; a handle 20, with one or more slots 50 open to an outside surface 25 of the handle 20; and an engagement means 40 for opening and closing the knife such that when closed the knife is engaged with the handle substantially along the length of the handle. In preferred aspects of the present invention, when the knife 10 is closed, shown in FIG. 2 through FIG. 7, the slot 50 exposes a portion 51 of the cutting surface 31 of the blade 30, and the slot 50 permits using the blade 30 to cut items without opening the knife. In preferred aspects of the present invention, the slot 50 is sized to allow or to guide the passage of materials to be cut onto the exposed portion 51 of the blade 30, while optionally protecting the user, subject or victim.

In certain aspects of the present invention, the slot 50 is generally curved and guides materials to be cut onto the blade 30 and 51, while the knife 10 is closed, FIG. 2 and FIG. 4. In other aspects of the present invention, the slot 50 is generally straight and guides materials to be cut onto the blade 30 and 51 to be cut, while the knife 10 is closed. In preferred aspects of the present invention, when the knife 10 is in the closed position FIG. 2 and FIG. 4, the knife 10 is generally able to cut the same materials that the blade 30 is able to cut when the knife 10 is in the opened position FIG. 1, as long as the material fits into the slot 50. The materials to be cut include, but are not limited to, seatbelts, webbing, harnesses, rope, string, yarn, banding, “zip ties”, “flex cuffs” and the like, light weight cording, medium weight cording, heavy weight cording, thin wire, small branches and sticks, paper and cardboard, skin, hair, shoe laces, CORDURA®, plastic and clothing.

The present invention contemplates a variety of arrangements for the slot 50 and the blade 30. In certain aspects of the present invention, the slot 50 begins near the midpoint 21 of the handle 20 and angles generally towards the butt end 22 of the handle 20. In additional aspects of the present invention, the slot 50 begins near the midpoint 21 of the handle 20 and angles generally toward said front end 23 of the handle 20. In further aspects of the present invention, the slot 50 begins generally near the butt end 22 of the handle 20 and angles generally towards the midpoint 21 of the handle 20. In still further aspects of the present invention, the slot 50 begins in the butt end 22 of the handle 20 and extends generally toward the midpoint 21 of the handle 20. In additional further aspects of the present invention, the slot 50 begins generally near the front end 23 and angles generally towards the midpoint 21 of said handle 20.

In certain aspects of the present invention, the knife 10 is foldable and the blade 30 is retained within the handle 20 when the knife 10 is closed FIG. 2 through FIG. 7. The present invention contemplates various methods of opening the knife 10. In certain aspects of the present invention, the blade 30 has a gripping region 32 or finger grasping protrusion 32, which may include a thumb stud or a finger hole, for opening a folding knife 10. In certain aspects of the present invention, the engagement means 40 includes a pivot means for opening the knife. Preferred aspects of the present invention include a locking mechanism for locking the blade in place when the knife 10 is open. In certain aspects of the present invention, the pivot means 40 and locking mechanism include, but are not limited to, a self-biasing cam lock assembly. Preferred aspects of the present invention include a cavity 24 for holding the blade 30 within the handle 20, when the knife 10 is closed. It follows that in certain aspects of the present invention, the user grips the blade 30, by the gripping region 32, and pulls the blade out of the cavity 24 in the handle 20. The user continues to pull the blade 30 and pivot the blade 30 about the engagement means 40, until the blade 30 and the handle 20 are properly engaged and the blade 30 locks into place. The knife 10 may then be used as knives customarily are used.

In other aspects of the present invention, the knife 10 is a switchblade type of device that operates on a spring mechanism and the blade is enclosed within a storage cavity 24 open at the front end 23, within the handle 20, when the knife is closed. In further aspects of the present invention there is a spring-loaded mechanism for ejecting the blade from the handle and thus opening the knife 10. The spring-loaded mechanism may include a spring-biased latch. Preferred aspects of the present invention include a locking mechanism for locking the blade 30 in place when the knife 10 is open. It follows that in certain embodiments of the present invention, that the user holds the handle 20 and actuates the spring mechanism and the locking mechanism. This causes the blade 30 to eject from its storage cavity 24 in the handle 20 and become engaged with the handle 20. After the blade 30 and the handle 20 have become engaged, the knife 10 can be used as knives customarily are used.

The present invention also contemplates a knife 150 that is not closable or movable, but is covered by a removable sheath or scabbard 155. In this aspect of the present invention, the sheath has at least one slot 130 for exposing the blade 100 of the knife 150 for cutting without unsheathing the blade 100.

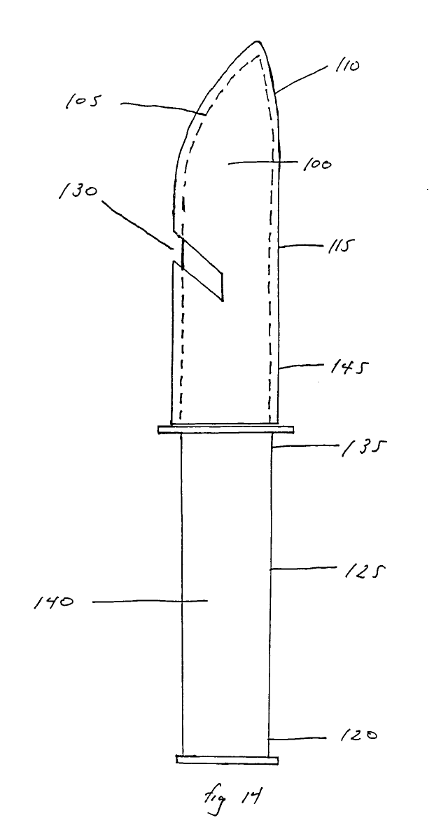

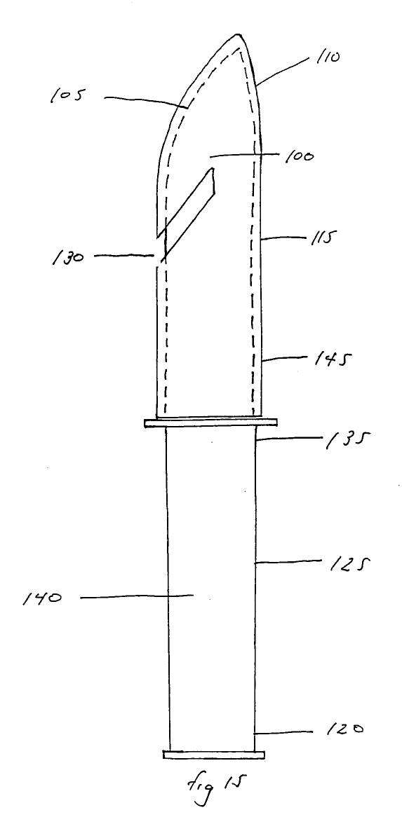

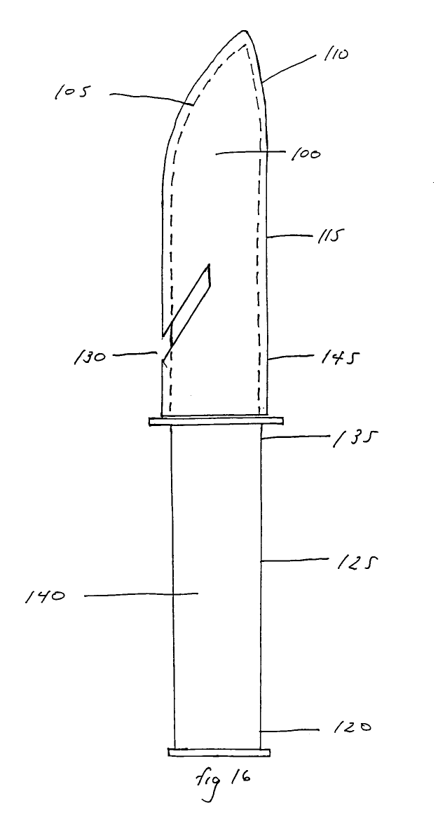

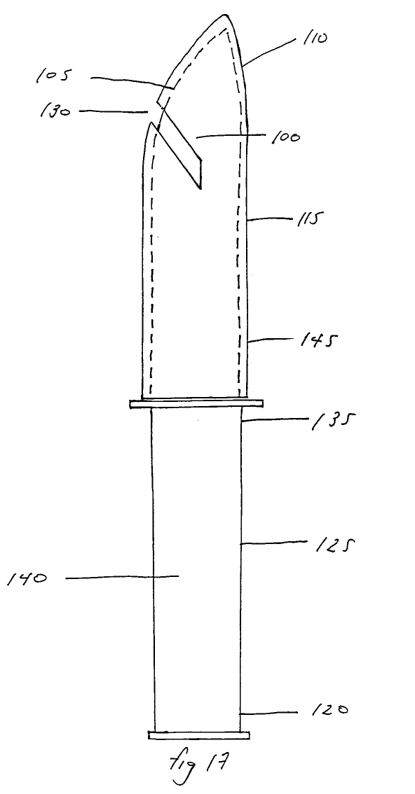

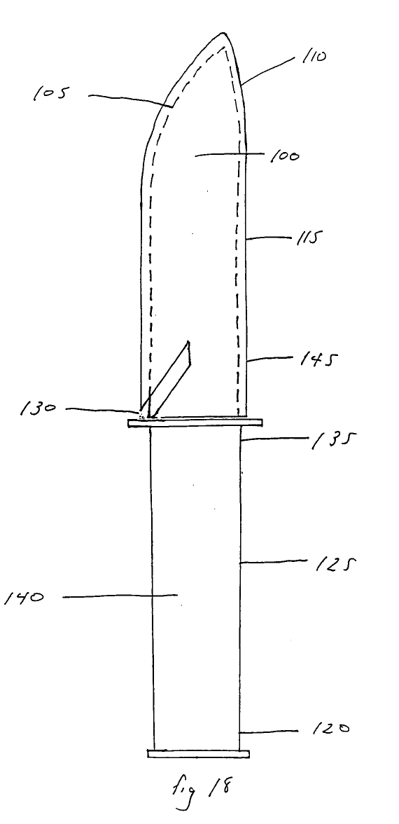

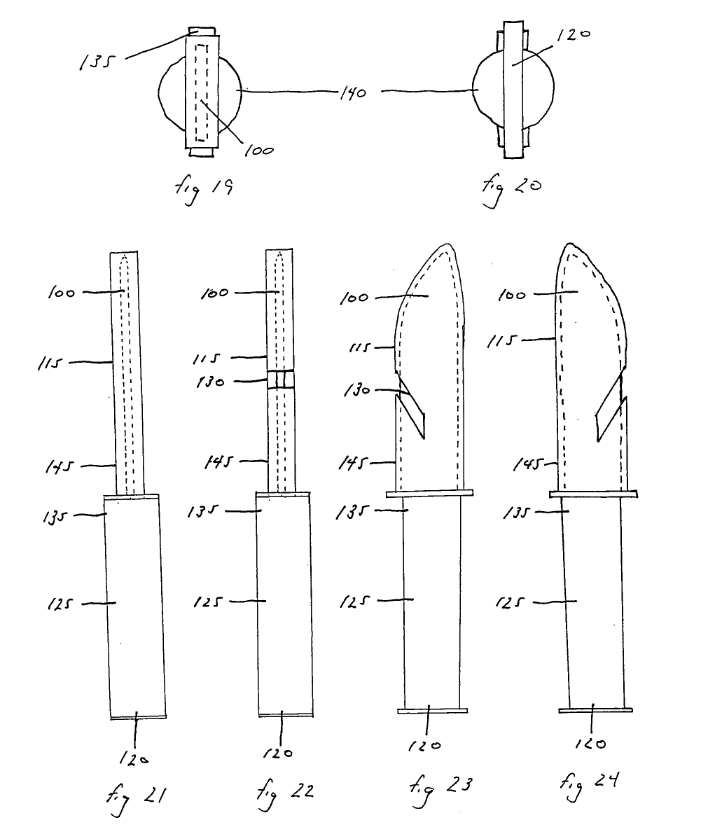

In certain aspects of the present invention, the slot 130 is generally straight and guides materials onto the blade 100 to be cut. In preferred aspects of the present invention, when the knife 150 is inside the removable scabbard FIG. 14 through FIG. 24, the knife 150 is generally able to cut the same materials that the blade 100 is able to cut when the knife 150 is removed from said scabbard 155, as long as the material fits into the slot 130 and may be applied to the cutting surface 105. The materials to be cut include, but are not limited to, seatbelts, webbing, harnesses, rope, string, yarn, banding, “zip ties”, “flex cuffs” and the like, light weight cording, medium weight cording, heavy weight cording, thin wire, small branches and sticks, paper and cardboard, skin, hair, shoe laces, CORDURA®, plastic and clothing.

The present invention contemplates a variety of arrangements for the slot 130 and the blade 100. In certain aspects of the present invention, the slot 130 begins near the midpoint 115 of said scabbard 155 and angles generally towards the butt end 145 of said scabbard 155. In additional aspects of the present invention, the slot 130 begins near the midpoint 115 of said scabbard 155 and angles generally toward the front end 110 of said scabbard 155. In further aspects of the present invention, the slot 130 begins generally near the butt end 145 of the scabbard 155 and angles generally towards the midpoint 115 of the scabbard 155. In still further aspects of the present invention, the slot 130 begins in the butt end 145 of the scabbard 155 and extends generally toward the midpoint 115 of the scabbard 115. In additional further aspects of the present invention, the slot 130 begins generally near the front end 110 and angles generally towards the midpoint 115 of the scabbard 155.

The blade 100 may be made of a variety of metals and metal combinations, plastics, ceramic, and the like, that are commonly used in the art, such as, but not limited to, aluminum and steel. The blade 100 may be tempered or cryogenically hardened to increase its strength. In certain aspects of the present invention, the blade 100 my have a single cutting surface 105. In further aspects, the blade 100 may have two cutting surfaces 105. In preferred aspects of the present invention at least a portion of the cutting surface 105 of the blade 100 is serrated. A variety of serration patterns that are commonly used in the art are acceptable. Serration of the blade 100 can promote the cutting of certain materials by protecting the sharpness of the cutting surface 105 and gripping the material being cut. In certain aspects of the present invention, the blade 100 is spear-pointed. In further aspects of the present invention, the blade 100 broadens at the end near the scabbard or sheath 155.

The present invention contemplates making the handle 140 out of a variety of materials. The materials include, but are not limited to metal, plastic, wood and bone. The present invention also contemplates making the sheath out of a variety of materials. The materials include, but are not limited to metal, plastic, leather, wood and bone. In preferred aspects of the present invention the handle 140 or sheath or scabbard 155 is generally contoured to fit in the user's hand. In further aspects of the present invention, the handle 140 or sheath or scabbard 155 is texturized for improved gripping. In certain aspects of the present invention, the handle 140 or sheath or scabbard 155 includes a mechanism for securing the knife 150 to the user or other supporting member. These mechanisms include, but are not limited to, a clip, a hook, a snap shackle and a lanyard attachment hole, and may be located generally near the front 135 or the midpoint 125 or the butt end of the handle 120.

### EXAMPLES

### Example 1

There are many methods of manufacturing knives. For example, the blade is forged of aluminum, tempered for strength, and sharpened. Molds for the parts of the handle are made and the handle is cast of military grade plastic. Then the blade and the handle parts, and the locking and pivot means, are assembled into a functional knife.

### Example 2

Vehicle accidents happen frequently. During the accident, the seatbelts automatically lock to prevent the occupants from being thrown from the vehicle or around the interior of the vehicle. When the seatbelts lock, it becomes difficult to unlock them. This can make it difficult for the accident victims to escape from the vehicle quickly or for a rescuer to remove the victim quickly. For example, this type of necessity may arise after the accident if there is a vehicle fire or if the victim's injuries are so sever that the victim needs immediate medical attention. In such a situation, an accident victim or a rescuer can slip the present invention between the seatbelt and the victim, slide the seatbelt into the slot and cut the seatbelt, without opening the knife and risking additional injury. Similarly, if the accident victim needs medical attention, the removal of clothing is often required and the victim may not be physically able to perform such an action. In this kind of situation, an emergency worker can slip the clothing into the slot of the present invention and cut the clothing off quickly, without having to open the knife and possibly cutting the victim or himself.

### Example 3

Skydiving can be a dangerous sport. Occasionally, for example, the diver's parachute can become entangled in a tree. In this type of situation, the skydiver must be able to remove the parachute to reach the ground. In military situations, this is vitally important so that the skydiver will not be captured by the enemy. Using the present invention, the diver can cut the parachute cords or harness to free himself, and proceed to the ground. In other situations, if the skydiver is jumping over water, the skydiver must get out of his harness quickly because the parachute can fill with water and sink under the surface of the water, drowning the skydiver. In such a situation, the skydiver would have only a few minutes to cut the harness and get out of the harness, before the parachute dragged him under the water. In additional situations, sometimes it is very windy when the skydiver reaches the ground. In this case, the skydiver can be pulled along the ground by the wind in the parachute. If this happens, the skydiver must get out of his harness quickly, and he can do so by cutting the harness with the present invention.

### Example 4

There are many situations where a person or animal may become entangled in string, rope, fishing line or wire. For example, pets may occasionally become tangled in string while roaming the neighborhood. In this situation, a regular knife would certainly cut the animal while being used to remove the string, particularly if the animal was injured or under stress, or simply squirming around. The present invention can be conveniently carried in a pocket or on a belt and would cut the string without cutting the animal, because the entire blade would not be exposed and the slot would guide the string onto the blade to be cut while keeping the flesh of the animal away from the blade.

### Example 5

Fish and game personnel often find animals, such as seals, dolphins and birds, entangled in fishing line nets or the plastic rings used to sell a six-pack of soda or beer. Usually, if the entrapping material is not removed promptly, the animal will die of drowning, starvation or strangulation. These animals are found in a state of great distress and struggling. However, the present invention can be conveniently carried by the worker and used to free animals without cutting the animal.

### Example 6

The present invention is useful in everyday situations. For example, it can be used to cut ribbon or string when wrapping a present. The present invention can also be used while gardening or working on a farm, because it can be conveniently carried in a pocket or clipped to a belt and used to cut string and rope in common situations.

### Example 7

Law enforcement personnel often use “flex cuffs,” the self-locking plastic binding that many of us have seen used to binding electrical cables and wires behind our desks, instead of traditional metal handcuffs. To remove the “flex cuffs”, they must be cut off with scissors or a knife. The present invention would make it possible to perform this operation without cutting the prisoner.

### Example 8

In military situations knives are carried for use as a weapon and for cutting materials such as webbing, rope and the like. Often, it is necessary to cut these materials in the field under stress, such as under fire. It would be convenient to have a knife that could be used to cut these types of materials quickly without opening the knife. This would prevent the user from accidentally cutting himself, other personnel, or materials to which the webbing or rope was attached. Aircrew personnel and assault craft crewmen would routinely find the present invention useful. For example, while on exercises, aircrew and water assault craft personnel regularly find themselves working at night on unstable platforms. Cutting any materials under these situations can be quite dangerous. The knifes of the present invention would reduce or eliminate many of the hazards of cutting materials while the user is in motion.

### Example 9

In SCUBA diving situations, knives are often carried for use as a tool. If a diver becomes entangled, then he may be killed. In such an accident, the diver must cut away the entangling material. However, low visibility due to darkness, silt or phosphorescence can make such an operation difficult and increase the danger of an open blade. The present invention would make it possible for the diver to cut away the entangling material without risking further injury from the blade of the knife.

1. A knife, comprising:
a. a handle, comprising a butt end and a front end, and further comprising at least one slot open to an outside surface of said handle;
b. a knife blade, comprising at least one cutting surface; and
c. a pivotably mounted engagement means to reversibly engage said knife blade with said handle; wherein when said knife blade is engaged with said handle substantially along the length of said handle, at least a portion of said at least one cutting surface of said knife blade is exposed by said slot;
i. further wherein said slot begins near the midpoint of said handle and angles generally toward said butt end, or
ii. further wherein said slot begins near the midpoint of said handle and angles generally toward said front end, or
iii. further wherein said slot begins generally near said butt end and angles generally toward the midpoint of said handle, or
iv. further wherein said slot begins generally near the front end and angles generally toward the midpoint of said handle, or
v. further wherein said slot begins in said butt end and extends generally toward the midpoint of said handle.

2. The knife of claim 1, wherein said slot begins near the midpoint of said handle and angles generally toward said butt end.

3. The knife of claim 1, wherein said slot begins near the midpoint of said handle and angles generally toward said front end.

4. The knife of claim 1, wherein said slot begins generally near said butt end and angles generally toward the midpoint of said handle.

5. The knife of claim 1, wherein said slot begins generally near the front end and angles generally toward the midpoint of said handle.

6. The knife of claim 1, wherein said slot begins in said butt end and extends generally toward the midpoint of said handle.

7. The knife of claim 1, wherein said handle is generally elongated.

8. The knife of claim 1, wherein said handle further comprises one or more gripping surfaces.

9. The knife of claim 1, wherein said handle is generally contoured to fit in a person's hand.

10. The knife of claim 1, wherein said slot is curved.

11. The knife of claim 1, wherein said slot is straight.

12. The knife of claim 1, wherein said at least one slot is operable to guide materials onto said knife blade.

13. The knife of claim 1, wherein said knife blade further comprises a gripping region.

14. A knife, comprising:
a. a removable scabbard, comprising a butt end and a front end, and further comprising at least one slot open to an outside surface of said scabbard;
b. a knife blade, comprising at least one cutting surface; and
c. a handle, attached to said knife blade, wherein when said knife blade is engaged with said scabbard, at least a portion of said at least one cutting surface of said knife blade is exposed by said slot;
i. further wherein said slot begins near the midpoint of said scabbard and angles generally toward said butt end of said scabbard, or
ii. further wherein said slot begins near the midpoint of said scabbard and angles generally toward said front end of said scabbard, or
iii. further wherein said slot begins generally near said butt end of said scabbard and angles generally toward the midpoint of said scabbard, or
iv. further wherein said slot begins generally near the front end of said scabbard and angles generally toward the midpoint of said scabbard, or
v. further wherein said slot begins in said butt end of said scabbard and extends generally toward the midpoint of said scabbard.

15. The knife of claim 14, wherein said slot begins near the midpoint of said scabbard and angles generally toward said butt end of said scabbard.

16. The knife of claim 14, wherein said slot begins near the midpoint of said scabbard and angles generally toward said front end.

17. The knife of claim 14, wherein said slot begins generally near said butt end and angles generally toward the midpoint of said scabbard.

18. The knife of claim 14, wherein said slot begins generally near the front end and angles generally toward the midpoint of said scabbard.

19. The knife of claim 14, wherein said slot begins in said butt end and extends generally toward the midpoint of said scabbard.

20. The knife of claim 14, wherein said scabbard is generally elongated.

21. The knife of claim 14, wherein said slot is curved.

22. The knife of claim 14, wherein said slot is straight.

23. The knife of claim 14, wherein said at least one slot is operable to guide materials onto said knife blade.
